(19) United States
(12) Patent Application Publication
(10) Pub. No.: US 2004/0206563 A1
(43) Pub. Date: Oct. 21, 2004

(54) ASSIST CONTROL OF POWER ASSISTED VEHICLE

(75) Inventor: Kazuhiro Murata, Mori-machi (JP)

Correspondence Address: ERNEST A. BEUTLER, ATTORNEY AT LAW, 10 RUE MARSEILLE, NEWPORT BEACH, CA, 92660, US

(73) Assignee: KABUSHIKI KAISHA MORIC, Mori-machi (JP)

(21) Appl. No.: 10/709,061

(22) Filed: Apr. 9, 2004

(30) Foreign Application Priority Data
Apr. 15, 2003 (JP) 2003-110291

(51) Int. Cl. B62K 11/00

(52) U.S. Cl. 180/205

(57) ABSTRACT

A power assisted, manually operated vehicle wherein the amount of energy required for the assist is reduced and the riders sensation is improved by continuing the application of power during times when manual power is still being exerted but no manual power is transmitted to the propulsion device because of the geometry of the transmission system so that the cyclic variations and amplitude of the power assist are reduced.

### BACKGROUND OF INVENTION

This invention relates to a power assisted, manually operated vehicle and more particularly to a control for the power assist that gives the operator a better feel in the vehicle operation.

A wide variety of normally manually operated vehicles are provided with prime mover power assists. Preferably the amount of power assist is related to the amount of manual input force so that the user still receives exercise from the vehicle operation. The types of vehicles so assisted take many forms including, but not limited to, land vehicles such as wheeled vehicles like bicycles and wheelchairs. However the practice is not necessarily limited to land vehicles but may also apply to light aircraft or water vehicles.

Also the power assist may be provided by a variety of prime movers such as electric motors or internal combustion engines. The manual input may be from an operator's legs or arms and is generally applied through a device that is supported for movement about an axis such as a pedal or hand wheel. As a result of this the actual input force will vary cyclically even if the force applied by the user is or is intended to be constant. These variations are between zero force at top and bottom dead center positions and vary generally sinusoidally in between thus magnifying the varying of the power assist.

Also since with prior art type of devices the amount of assist is generally proportional to the input force measured, the power assist varies significantly during a single force application cycle. This results in inefficient power consumption by the assist device and a somewhat uncomfortable feel to the operator or user. This will become more apparent when FIG. 5 is discussed during the Detailed Description.

A typical prior art device of this type is shown in Japanese Patent Publication Heill-171081, dated Jun. 21, 1999. In addition to operating as discussed above and having the noted defects, this construction permits setting of the assist ratio depending on such factors as the user's age, his strength, the distance to be traveled and the amount of exercise desired. However like the prior art mentioned, the assist varies during each cycle of operation of the pedals so that the aforenoted problems are still present.

It, therefore, is a principal object of this invention to provide an improved power assisted vehicle where the power assist is related to the sensed manual force input, but where it is not varied to the full extent of cyclical variations in input.

### SUMMARY OF INVENTION

A first feature of this invention is adapted to be embodied in a power assisted, manually operated vehicle. The vehicle is comprised of a propulsion device for moving the vehicle along a terrain. A manual operator is provided that is adapted to receive a manual input force from an operator. A transmission operates the propulsion device from the force applied to the manual operator. A prime mover is also in driving relation with the propulsion device. A force sensor senses the force applied to the transmission from the manual operator. In accordance with the invention, an arithmetic calculator measures the variations in the force sensed by the force sensor and determines an assist force in operating the prime mover.

Another feature of this invention is adapted to be embodied in a method of determining the amount of power assist for power assisted, manually operated vehicle as set forth in the preceding paragraph. In accordance with this feature of the invention, variations in the force sensed by the force sensor measured and the assist force for operating the prime mover is determined by the calculator depending on the variations.

### BRIEF DESCRIPTION OF DRAWINGS

FIG. 1 is a graphical view showing the variation in force and assist during a series of cycles and when climbing a hill in accordance with the invention and with the prior art.

FIG. 2 is a view showing the actual force and its processed output in accordance with an embodiment of the invention.

FIG. 3 is a force diagram, in part similar to FIG. 2, but in accordance with another embodiment.

FIG. 4 is a block diagram showing an embodiment of the invention.

FIG. 5 is a series of graphical views showing the varying conditions in accordance with the invention (FIGS. 5A-5E) and in accordance with the prior art (FIGS. 5F and 5G).

FIG. 6 is a block diagram showing the control routine in accordance with the invention.

### DETAILED DESCRIPTION

Before describing a structure embodying the invention, the theory and strategy employed will be first described by certain graphical views. As will become apparent, some of these views also include comparisons with the prior art.

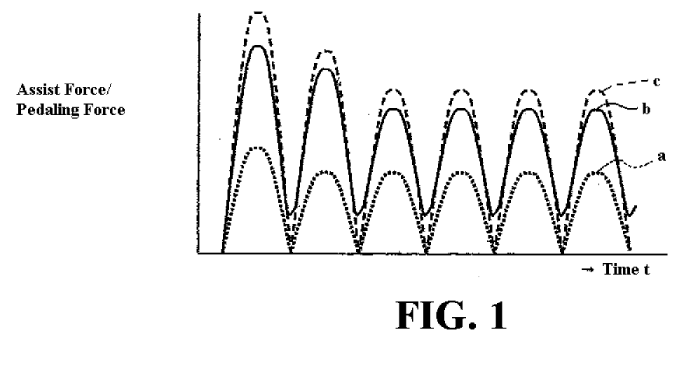

Referring first to FIG. 1 and as is discussed above, this is a graph illustrating the waveforms of the torque and the assist force of a power assisted bicycle according to the present invention. These are the waveforms under the condition when the bicycle is climbing a hill. It should be noted that the constructions and methods of operation described can be carried out with any of the power assisted manually powered vehicle types regardless of the type of vehicle or the type of assist device. However an electric motor assisted bicycle is utilized as an example for explanation.

In this figure, the curve “a” shown by a dotted line represents the detected torque value generated by the pedaling force and detected by a torque sensor of any desired type. The curve “b” shown by a solid line represents the assist force generated by driving an electric motor based on the processed torque value obtained by the arithmetic processing performed according to a torque control method of the present invention. The curve “c” shown by a broken line represents the assist force applied with a conventional torque control method.

As is seen from this graph, when the detected torque generated by the pedaling force (curve “a”) is zero or very small at the bottom dead center, the conventional assist force (curve “c”) is almost zero whereas the assist force according to the present invention (curve “b”) is not zero, because assist force is continued to be applied.

This means that since the variation of the driving current of the electric motor is reduced, the driving energy efficiency can be improved and the power consumption can be reduced. With the improvement of energy efficiency, the battery consumption can be reduced. This increases the service life of the battery and enables the bicycle to run a long distance on a little power. In addition, since assist force is kept applied even when the pedaling force becomes zero or very small, the rider will feel stable and have good ride feeling.

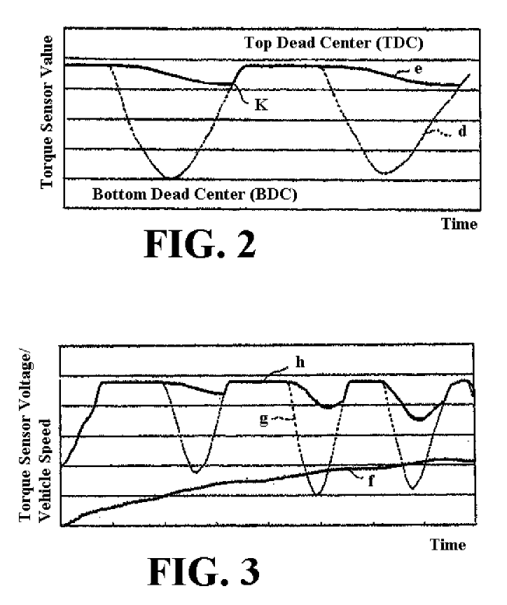

The way this is done is shown graphically by FIG. 2 which is a graph illustrating the processed torque value according to the present invention. The curve “d” shown by a dotted line represents the detected torque value before the arithmetic processing and is generally the same as the curve “a” in FIG. 1. The curve “e” represents the processed torque value obtained by the arithmetic processing.

The detected torque value (curve “d”) periodically varies in synchronization with the pedaling force. The arithmetic processing on the detected torque is started when the detected torque value starts decreasing from its peak corresponding to the top dead center of the detected torque curve. In one example of applying this method, decreasing torque rates, decreases in the torque in a unit time depending upon the detected torque value are determined in advance. The decrease rates represent the descending gradients of the curve.

The value is continually decreased by a decrease rate determined by the magnitude of the detection output (V) from the torque sensor at predetermined time intervals (ms). For example, when the detected torque value is high, the decrease rate (descending gradient) is kept small. When the detected torque value becomes low, the decrease rate is increased. A map corresponding to the detected torque values is produced in advance and the arithmetic processing is performed according to the map.

As a result of this, the processed or resulting output torque curve (curve “e”) descends gradually with a gentle gradient from a detected torque value. The detected torque value (curve “d”) increases when the pedal passes the bottom dead center, When the detected torque value exceeds the processed torque value, the arithmetic processing is suspended (the processing amount is made zero) and the detected torque value is regarded as the processed torque value. As a result, the processed assist amount torque curve (curve “e”) shown by a solid line is obtained. Thus it is possible to obtain a smoother performance and actually provide a lesser maximum torque output as seen from FIG. 1. Thus electrical power consumption is actually reduced.

Based on the processed torque value, the driving current which provides a specified assist ratio to the processed torque is calculated, and the electric motor is driven by the current to obtain assist force, Since the processed torque is high when the pedaling force is at the bottom dead center position, assist force can be obtained even when the pedaling force is at the bottom dead center position.

FIG. 3 is a graph illustrating the processed torque is derived according to another embodiment of the invention. This in an example in which the arithmetic processing is performed also taking the vehicle speed into account. In this view, the curve “f” represents the vehicle speed. The curve “g” represents the detected torque value. The curve “h” represents the processed torque value.

As is clear from the graph, when the vehicle speed is high, the decrease rate is increased to decrease the processed torque value. When the vehicle speed is low, the decrease rate is decreased to increase the processed torque value, Thus, high assist force can be generated when the bicycle is running a low speed such as when it is climbing a hill or just after starting whereas the assist force will be reduced to prevent excessive consumption of assisting energy when the vehicle speed is high.

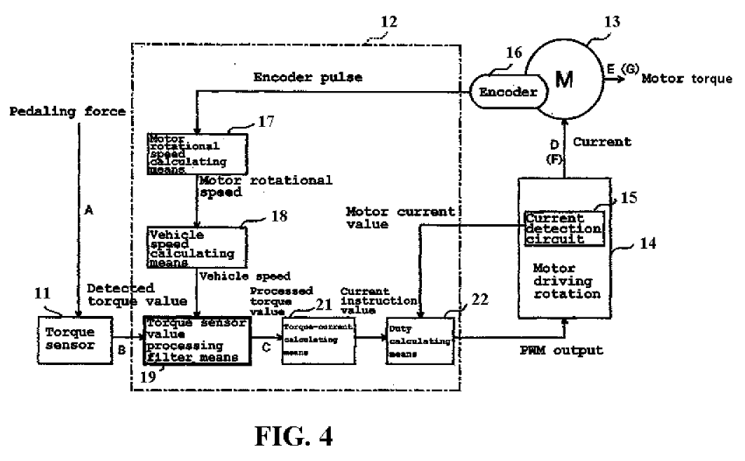

Having thus described two embodiments where a processed torque is obtained from the force sensor output to modify the amount of assist torque, a physical embodiment of the invention will be described by reference to FIG. 4. Again those skilled in the art should readily understand from the description that the invention can be employed with a large variety of power assisted manually propelled vehicles. Bearing this in mind, FIG. 4 is a block diagram of a torque control device for a power assisted bicycle according to the present invention.

The assist torque control device includes a torque sensor 11, of any desired type, for detecting the manually input pedaling force, a controller 12 for calculating the driving current to drive an electric assist motor 13, also of any desired type such as a pulse width modulated motor based on the torque detected by the torque sensor 11. A motor driving circuit 14 is provided for powering the electric motor 13 according to a driving signal from the controller 12. The circuit 14 includes a current detection circuit (ampere meter) 15 for detecting the current in the motor 13, and an encoder 16 for detecting the rotational speed of the motor 13.

The controller 12 is comprised of a CPU, by way of example, and has motor rotational speed calculating means 17 having a software program or a hardware circuit programmed in advance. The CPU also has a vehicle speed calculating circuit 18, torque sensor value processing circuit 19, a torque current calculating circuit 21, and a duty calculating circuit 22.

The pedaling force detected by the torque sensor 11 during running is arithmetically processed in the torque sensor value processing filter 22 based on the detected torque in accordance with one of the methods already described and the vehicle speed. The vehicle speed is calculated by the motor rotational speed calculating means 17 and the vehicle speed calculating means 18 based on a pulse signal from the encoder 16 and inputted into the processing filter means 19 in the controller 12.

The processed torque value is inputted into the torque current calculating means 21, which calculates a current instruction value according to the processed torque, Based on the current instruction value, the duty calculating means 22 calculates a duty ratio of a driving pulse. The driving pulse is inputted into the motor driving circuit 14 as a PWM output to drive the motor 13. The driving current of the motor 13 is detected by the current detection circuit 15 and provided to the duty calculating circuit 22 for feedback control.

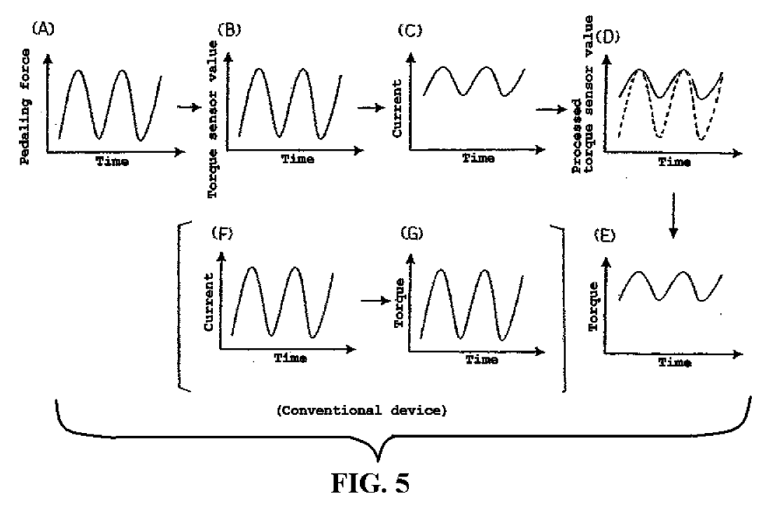

As has been noted in the brief description of these figures, FIG. 5(A) to FIG. 5(E) illustrate the signal waveforms and these are determined at the positions A to E, respectively, in FIG. 4. As has also been noted in the brief description, FIG. 5(F) and FIG. 5(G) illustrate conventional signal waveforms that would occur at the positions F” and G, respectively, in FIG. 4 for reference purpose. Specifically, FIG. 5(A) illustrates the waveform of the observed pedaling force which varies periodically in synchronization with the rotation of the pedal. FIG. 5(B) illustrates the waveform of the detected torque generated by the pedaling force and detected by the torque sensor 11. The detected torque varies periodically with large amplitude in synchronization with the pedaling force, as shown in FIG. 5(A).

FIG. 5(D) illustrates the waveform of the processed torque obtained by the arithmetic processing in the processing filter means 22. The dotted line shows the torque before the processing, which has the same waveform as the curve shown in FIG. 5(B). By the processing, the curve, including the values at the bottom dead center, is shifted to the high torque side without shifting the torque at the top dead center and the variation becomes smaller. Thus the feel to the user is improved and power consumption is reduced at the same time.

FIG. 5(C) illustrates the waveform of the driving current of the motor 13. The variation of the driving current is small in accordance with the processed torque value as compared with the conventional curve of FIG. 5(F). FIG. 5(E) illustrates the waveform of the motor torque. The low torque side parts of the curve are shifted to the high torque side in accordance with the current waveform shown in FIG. 5(C) and the variation is smaller as a whole than that of the conventional curve shown in FIG. 5(G).

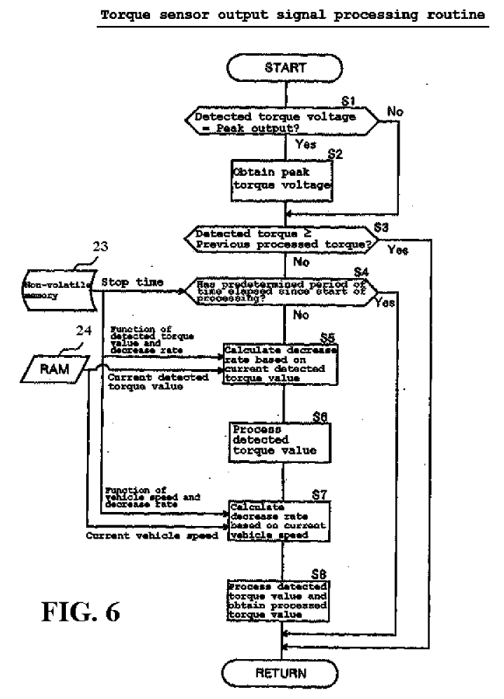

The control routine by which the controller 12 of the system shown in FIG. 4 provides the processed torque value shown in FIG. 5(C) will now be described by reference to FIG. 6. The routine is repeated by the CPU of the controller 12 shown in FIG. 4 at predetermined time intervals (a few ms, for example). The operation as follows.

After Start at step S1, it is determined whether the detected torque voltage is the peak voltage. This is to perform an arithmetic processing to make the gradient at the time when the torque voltage decreases from its peak less steep to increase the torque value. The judgment is made by analyzing the waveform of the output voltage data from the torque sensor 11, for example. If the detected torque voltage is the peak voltage, the process goes to step S2. Otherwise, the process goes to step S3.

If the process moves to the step S2 to set the peak voltage when the voltage is sensed to decrease. Then the last voltage before the peak is set as the peak voltage at the step S2.

If at the step S1 the voltage is not equal to the peak voltage set at the step S2, the program moves to the step S3 while the detected torque voltage is decreasing from the peak (while the processing routine is repeated at predetermined intervals of a few ms). At the step S3 it is judged whether the detected torque exceeds the previous processed torque. If the detected torque exceeds the processed torque (at the time at the point K in FIG. 2), the processing operation is suspended and the routine is terminated.

However if at the step S3 if the detected torque is lower than the processed torque, the process goes to step 54 if this is the first processing routine after a peak. At the step S4, it is judged whether a predetermined period of time has elapsed since the start of the processing. The predetermined period of time is stored in a non-volatile memory 22. When the predetermined period of time has elapsed, the processing operation is suspended and the routine is terminated. This is to eliminate a state where a processed torque value obtained by the arithmetic processing is maintained and assist force is kept supplied from the electric motor even after the pedals have been stopped and the torque has become zero within a short period of time. The assist force from the electric motor can be thereby shut down and the bicycle can be returned to the normal running mode immediately after the pedals are stopped and the torque becomes zero. Thus, since the braking force necessary to stop the bicycle can be prevented from being increased by the assist force and the bicycle can be stopped with a proper braking force, the rider can have a stable and comfortable bicycle ride.

If however at the step S4 the predetermined time period has not run, the processing operation is continued and moves to the Step S5 where a decrease rate is calculated based on the current detected torque value, In this case, the functional equation between the detected torque value and the decrease rate is stored in advance in the nonvolatile memory 23 as a one-dimensional map. The current torque sensor value is read out from a RAM 24 into which the output data from the torque sensor have been written. The non-volatile memory 23 and the RAM 24 can be provided in the processing filter means 19 in the controller 12 shown in FIG. 4.

The program then moves to the step S6 where the detected torque sensor value is arithmetically processed according to the map in step S5. This arithmetic processing is performed by the processing filter means 19 shown in FIG. 4.

Then if in accordance with the method that also utilizes vehicle speed as described by reference to FIG. 3, the program moves to the step S7. At this step, the processing filter means 22 shown in FIG. 4 calculates a decrease rate based on the current vehicle speed. The relational expression between the vehicle speed and the decrease rate is determined as a map of the rate between the torque value processed based on the detected torque calculated in step S6 and the detected torque before the processing. The processing amount can be thereby adjusted based on the vehicle speed. The map is read out from the non-volatile memory 23 and the current vehicle speed is read out from the RAM 24.

Then the program moves to the step S8 where arithmetic processing is performed based on the map in step S7 to process the detected torque value processed in the step S6 to obtain a processed torque value. The program then repeats.

Thus from the foregoing description it should be readily apparent that the described methods and apparatus that the gradient of the detected torque curve is changed according to the torque and the torque curve is changed in shape into a processed torque curve. Since the driving current of the electric motor is calculated based on the processed torque curve, the torque at the bottom dead center can be increased without decreasing the detected torque at the top dead center. Since the periodic variation in the detected torque value is thereby reduced and the variation of the driving current of the electric motor can be reduced, the driving energy efficiency can be improved and the power consumption can be reduced. With the improvement of energy efficiency, the battery consumption can be reduced. This increases the service life of the battery and enables the vehicle to run a long distance on a little electric power. In addition, since assist force is kept applied even when the pedaling force becomes zero or very small, the rider can constantly feel stable and powerful assist force during running and have good ride feeling. In addition, the decrease rates may be changed based on the vehicle speed. When the vehicle speed is low, the decrease rates are decreased to maintain the processed torque curve on the high torque side, When the vehicle speed is high, the decrease rates are increased to reduce the assist force, Thus, large assist force can be generated when the bicycle is running at a low speed such as when it is climbing a hill or just after starting, and the assist force is reduced to prevent consumption of excessive assist energy when the bicycle is running at a high speed.

Of course those skilled in the art will readily understand that the described embodiments are only exemplary of forms that the invention may take and that various changes and modifications may be made without departing from the spirit and scope of the invention, as defined by the appended claims.

1. A power assisted, manually operated vehicle comprised of a propulsion device for moving said vehicle along a terrain, a manual operator adapted to receive a manual input force from an operator, a transmission operating said propulsion device from the force applied to said manual operator, a prime mover in driving relation with said propulsion device, a force sensor sensing the force applied to said transmission from said manual operator, an arithmetic calculator for measuring the variations in the sensed force by said force sensor and determining an assist force in operating said prime mover.

2. A power assisted, manually operated vehicle as set forth in claim 1, wherein the prime mover comprises an electric motor and the arithmetic calculator determines the amount of electrical power supplied to said electric motor.

3. A power assisted, manually operated vehicle as set forth in claim 1, wherein the manual operator is supported for movement about an axis.

4. A power assisted, manually operated vehicle as set forth in claim 3, wherein the manual operator comprises a pedal.

5. A power assisted, manually operated vehicle as set forth in claim 1, wherein the manual operator provides a cyclically varying power output in response to a constant application of user force during a cycle of operation of the manual operator due to the nature of the manual operator and the arithmetic calculator provides an assist force that also varies cyclically but with a smaller amplitude than that of the manual operator.

6. A power assisted, manually operated vehicle as set forth in claim 5, wherein the arithmetic calculator provides an assist force that is never zero when a manual force is being applied.

7. A power assisted, manually operated vehicle as set forth in claim 6, wherein the arithmetic calculator provides an assist force that is also related to vehicle speed.

8. A power assisted, manually operated vehicle as set forth in claim 1, wherein the manual operator provides a cyclically varying power output in response to a constant application of user force during a cycle of operation of the manual operator due to the nature of the manual operator and at a portion of the cycle the power output is zero even though a force is being applied and the arithmetic calculator provides an assist force that also varies cyclically but with a smaller amplitude than that of the manual operator and is never zero when a manual force is being applied.

9. A power assisted, manually operated vehicle as set forth in claim 8, wherein the detected torque is arithmetically processed in succession with predetermined decrease rates depending on the detected torque value at predetermined time intervals to obtain the processed torque value from the time when the detected torque value starts decreasing from a predetermined peak torque value.

10. A power assisted, manually operated vehicle as set forth in claim 8, wherein the arithmetic processing is suspended to make the amount of processing on the detected torque value zero from the time when said detected torque value starts to increase to exceed the processed torque value until the next peak in detected torque.

11. A power assisted, manually operated vehicle as set forth in claim 10, wherein the prime mover comprises an electric motor and the arithmetic calculator determines the amount of electrical power supplied to said electric motor.

12. A power assisted, manually operated vehicle as set forth in claim 11, wherein the manual operator is supported for movement about an axis.

13. A power assisted, manually operated vehicle as set forth in claim 12, wherein the manual operator comprises a pedal.

14. A method of controlling the amount of power assist of a power assisted, manually operated vehicle comprised of a propulsion device for moving said vehicle along a terrain, a manual operator adapted to receive a manual input force from an operator, a transmission operating said propulsion device from the force applied to said manual operator, a prime mover in driving relation with said propulsion device, a force sensor sensing the force applied to said transmission from said manual operator, said method comprising the steps of measuring the variations in the sensed force by said force sensor, determining an assist force by arithmetically processing the detected torque value that varies at specific rates of change depending on the sensed force and applying a force from the prime mover based on the processing.

15. A method of controlling the amount of power assist of a power assisted, manually operated vehicle as set forth in claim 14, wherein the manual operator provides a cyclically varying power output in response to a constant application of user force during a cycle of operation of the manual operator due to the nature of the manual operator and the assist force also varies cyclically but with a smaller amplitude than that of the manual operator.

16. A method of controlling the amount of power assist of a power assisted, manually operated vehicle as set forth in claim 15, wherein the assist force is never zero when a manual force is being applied.

17. A method of controlling the amount of power assist of a power assisted, manually operated vehicle as set forth in claim 16, wherein the assist force is also related to vehicle speed.

18. A method of controlling the amount of power assist of a power assisted, manually operated vehicle as set forth in claim 17, wherein the detected torque is arithmetically processed in succession with predetermined decrease rates depending on the detected torque value at predetermined time intervals to obtain the processed torque value from the time when the detected torque value starts decreasing from a predetermined peak torque value.

19. A method of controlling the amount of power assist of a power assisted, manually operated vehicle as set forth in claim 18, wherein the arithmetic processing is suspended to make the amount of processing on the detected torque value zero from the time when the detected torque value starts to increase to exceed the processed torque value until the next peak in detected torque is sensed.

20. A method of controlling the amount of power assist of a power assisted, manually operated vehicle as set forth in claim 19, wherein the prime mover comprises an electric motor and the arithmetic calculator determines the amount of electrical power supplied to the electric motor.
